(19) United States
(12) Patent Application Publication
(10) Pub. No.: US 2020/0276854 A1
(43) Pub. Date: Sep. 3, 2020

(54) SECURITY DEVICE, METHOD OF MAKING A SECURITY DEVICE AND METHOD OF AUTHENTICATING A PRODUCT

(71) Applicant: JOHNSON MATTHEY PUBLIC LIMITED COMPANY, London (GB)

(72) Inventors: Damien James GARDINER, Billingham (GB); Duncan William John MCCALLIEN, Billingham (GB); Felicity Jane ROBERTS, Billingham (GB)

(21) Appl. No.: 16/477,325

(22) PCT Filed: Jan. 16, 2018
(86) PCT No.: PCT/GB2018/050109

§ 371 Date: Jul. 11, 2019

(30) Foreign Application Priority Data
Jan. 20, 2017 (GB) 1701003.4

(51) Int. Cl. B42D 25/364; B41M 3/14; B42D 25/405

(52) U.S. Cl. CPC B42D 25/364; G07D 7/003; B42D 25/405; B41M 3/14

(57) ABSTRACT

A method of producing a security device (60) is disclosed. The method comprises inkjet printing a liquid crystal material onto a first region (61) of a substrate and ink jet printing the same liquid crystal material onto a second region (62) of the substrate. The volume of the liquid crystal material printed per unit area of the substrate in the first region of the substrate is different to the volume of the liquid crystal material printed per unit area of the substrate in the second region of the substrate such that the wavelength of the peak reflectance of the liquid crystal material on the first region is different to the wavelength of the peak reflectance of the liquid crystal material on the second region.

### FIELD OF INVENTION

The present invention concerns security devices, methods for making security devices and methods of authenticating products. In particular, but not exclusively, the invention relates to the inkjet printing of chiral nematic liquid crystal materials for the creation of security devices.

### BACKGROUND

Liquid crystal materials are a class of functional photonic materials. Liquid crystal materials contain molecules which have a tendency to self-organise along an optical axis. The way in which the molecules in liquid crystal materials self-organise and then macroscopically align dictates the optical properties of the liquid crystal material. For example, chiral liquid crystal molecules have a tendency to self-organize into a helicoidal arrangement around an optical axis in the material. Due to the difference in refractive index of the liquid crystal molecules parallel and perpendicular to the molecular optical axis, or birefringence, this helicoidal arrangement results in a periodic variation of the refractive index along the optical axis of the material. For suitable periodicities, this gives rise to a photonic band-gap or reflection band for visible wavelengths of circularly polarized light, which is well-known in the art. When viewed at different angles with respect to the helicoidal axis, the apparent reflection band changes according to the viewing direction.

The optical properties of chiral liquid crystal materials make them suitable for use in security devices for authentication by both untrained and trained personnel. Such security devices are typically added to many products, packaging, labels, items of value and documentation to permit validation and to confirm authenticity. Security devices where a printed liquid crystal image changes colour with viewing angle, or is revealed when viewed under particular polarisation conditions, are known. For example, US2011/0097557 discloses the manufacture of security features, e.g. for bank notes, in which a polymerisable liquid crystal material is printed onto a solid PVA layer. EP2285587 and U.S. Pat. No. 8,481,146 discuss inkjet printing of chiral nematic liquid crystals to give devices exhibiting optical variability with viewing angle. Effects such as colour shifts, wherein a security device exhibits a viewing angle dependent colour, are useful for printed security devices as they cannot be easily replicated with conventional inks.

It is desirable for security devices to exhibit optical effects that are readily apparent to the untrained eye and yet difficult to reproduce with conventional means. In addition, for example if security devices are to be attached to mass-produced articles, there is a need for security devices which exhibit such effects and yet can be produced rapidly and cost-effectively.

It may also be beneficial for a security device to include different levels of authentication to improve overall deterrence and resistance to counterfeiting. Overt features allow authentication by untrained personnel or members of the public and typically involve an easily recognisable optical effect or change upon viewing the feature in a certain way (for example, a colour shift on moving or rotating the feature). Covert features typically comprise a hidden feature that is revealed or shown by use of a viewing aid or instrument (e.g. ultraviolet activated visible fluorescence). So-called forensic features use a sophisticated, laboratory-based test to provide unequivocal evidence regarding the authenticity of an item (e.g. DNA amplification, GC-MS analysis of a dissolved taggant molecule).

It is particularly desirable that security devices can be changed on an item-level basis if so desired, for example by including a unique code or serial number, to permit additional tracking or serialisation of individual items.

A known approach to allow authentication of articles is to use a holographic security device, typically applied in the form of a pre-prepared label. By virtue of their production process, such holograms cannot be varied on an item level basis and each one is essentially the same. Such labels also need to be produced by a separate process and may be restricted in terms of surfaces or products to which they may be applied. Provision of a separate label may add extra expense to incorporation of the security device. It is therefore further desirable that security devices be added directly to items without the use of a pre-prepared label to both enhance security and reduce cost of the device.

The present invention seeks to provide improved security devices and methods.

### SUMMARY OF THE INVENTION

According to a first aspect of the invention there is provided a method of producing a security device, the method comprising inkjet printing a liquid crystal material onto a first region of a substrate and ink jet printing the same liquid crystal material onto a second region of the substrate, wherein the volume of the liquid crystal material printed per unit area of the substrate in the first region of the substrate is different to the volume of the liquid crystal material printed per unit area of the substrate in the second region of the substrate such that the wavelength of the peak reflectance of the liquid crystal material on the first region is different to the wavelength of the peak reflectance of the liquid crystal material on the second region.

When a conventional ink is printed at a varying volume per unit area, for example in greyscale printing, the wavelength of peak reflectance remains unchanged and instead the intensity of the reflected light changes with reducing volume of ink per unit area. This results in the well-known greyscale effect that can be achieved, for example, with black ink. Surprisingly however, in the present invention, the volume of the liquid crystal material printed per unit area of the substrate alters the wavelength of peak reflectance of the liquid crystal material. Thus the first region has a first wavelength of peak reflectance and the second region has a second wavelength of peak reflectance, the first wavelength of peak reflectance being different to the second wavelength of peak reflectance. Since the wavelength of peak reflectance affects the perceived colour, the first region has a first colour and the second region has a second, different colour. That means that an image with multiple different colours in different regions can be conveniently printed using a single liquid crystal material. Such an unusual visual effect is highly advantageous in the production of security devices as it allows the creation of visually attractive and readily recognisable overt security features with the use of a single liquid crystal material.

It is very desirable for a security device to exhibit both attractive and recognisable overt features, which can therefore contribute to the quality, look and feel of products or packaging, and covert features, which can provide high levels of certainty of authenticity under forensic examination. Liquid crystal materials can offer excellent covert security features, for example based on the polarisation property of light, and the present invention now permits liquid crystal materials to offer striking overt features using a single liquid crystal material. The combination of different levels of security features, in one printed security device, gives significantly enhanced protection against counterfeiting, and diversion, of items to which the security device is added.

Using a single liquid crystal material may reduce cost and/or increase the speed at which devices may be produced. The latter may be particularly important when the liquid crystal material is printed directly onto products or packaging as part of a production line. Ink jet printing is a preferred method for such applications, and the availability of striking overt security features by inkjet printing a single liquid crystal material is therefore advantageous. Preferably the liquid crystal material is therefore a liquid crystal ink formulated for inkjet printing. The liquid crystal material may be printed in a single pass. The liquid crystal material may be printed in multiple passes. The multiple passes may be multi-pass printing with a single print head, in which a single print head makes multiple passes across the substrate, or multi-pass printing with multiple print heads in which each print head makes one or more passes across the substrate. Multi-pass printing may be advantageous in producing striking visual effects.

The liquid crystal material is printed at a first volume per unit area in a first region of the substrate and a second volume per unit area in a second region of the substrate. Inkjet printers generally operate by the jetting of drops of ink on to the substrate. The drops are jetted from a print head either individually or in groups. The volume of liquid crystal material printed per unit area may be varied by varying the volume of the drops, by varying the spacing of the drops or of the groups of drops, by varying the number of drops within each group or by other methods. The volume per unit area may be determined by dividing the volume of liquid crystal material jetted onto the region by the area of that region. For example, two regions may each be a square having dimensions of 1 cm by 1 cm and the ink jet printer may print an array of drops across each region. The drops may for example be 10 pL each and the array may contain 400×400 drops in a first region and 1000×1000 drops in a second region. In that case, the volume of liquid crystal material printed per unit area in the first region would be 1.6 μL/cm² and the volume of liquid crystal material printed per unit area in the second region would be 10 μL/cm². Another used term is the print resolution, expressed in dots per inch (dpi). For example, the print resolution in a first region of the substrate may be 1016 dpi in both x and y directions (i.e. parallel to the movement of the print head and perpendicular to the movement of the print head) and in a second region the print resolution may be 2540 dpi. If the volume of the drop is again 10 pL, the volume of liquid crystal material printed per unit area in the first region is 1016²×(10 pL)/(2.54 cm)²=1.6 μL/cm² and the volume of liquid crystal material printed per unit area in the second region is 2540²×(10 pL)/(2.54 cm)²=10 μL/cm². It will be appreciated that the region could have any size or shape; the volume of liquid crystal material printed per unit area of the substrate in the region can still be determined from the number of drops printed on the region, the volume of those drops and the area of the region. Preferably all other aspects of the print process, such as for example jetting voltage, jetting frequency, non-jetting voltage, waveform, ink temperature, meniscus pressure, platen temperature and curing conditions, remain constant, with only the volume of liquid crystal material printed per unit area being changed. In other words, changing the volume of liquid crystal material per unit area may be sufficient to produce the difference in the wavelength of peak reflectance, without needing to change other print properties.

Preferably each region has an area of from not less than 1 mm² to not greater than 1 cm². More preferably each region has an area of from not less than 0.1 cm² to not greater than 1 cm². Yet more preferably each region has an area of from not less than 0.5 cm² to not greater than 1 cm². Preferably the printing of the liquid crystal material does not vary across the region. Thus the liquid crystal material may be printed in a regular array of droplets across the region or in a regular array of groups of droplets, with the pattern of droplets within each group being the same. The pattern of droplets within each group may be a regular or irregular pattern, but it is preferably the same pattern in each group.

Preferably the volume of the liquid crystal material printed per unit area of the substrate in the first region of the substrate and the volume of the liquid crystal material printed per unit area of the substrate in the second region of the substrate are both within the range from 0.01 to 20 μL/cm². More preferably the volume of the liquid crystal material printed per unit area of the substrate in the first region of the substrate and the volume of the liquid crystal material printed per unit area of the substrate in the second region of the substrate are both within the range from 0.1 to 15 μL/cm². Most preferably the volume of the liquid crystal material printed per unit area of the substrate in the first region of the substrate and the volume of the liquid crystal material printed per unit area of the substrate in the second region of the substrate are both within the range from 0.1 to 10 μL/cm². If the volume of liquid crystal material printed per unit area is too low, there may be insufficient liquid crystal material present on the substrate to generate a colour perceivable by the human eye. If the volume of liquid crystal material printed per unit area is too high, the cost of the security device may become excessive.

Preferably, the volume of the liquid crystal material printed per unit area of the substrate in the first region of the substrate differs from the volume of the liquid crystal material printed per unit area of the substrate in the second region of the substrate by at least 10%, relative to the volume of the liquid crystal material printed per unit area of the substrate in the first region. Preferably, the volume of the liquid crystal material printed per unit area of the substrate in the first region is at least 0.1 μL/cm², preferably at least 1 μL/cm² and more preferably at least 2 μL/cm² greater than the volume of the liquid crystal material printed per unit area of the substrate in the second region. A difference of that magnitude may ensure that the difference between the wavelengths of the peak reflectance in the first and second regions is sufficient to create a striking visual effect. For example, the volume of liquid crystal material printed per unit area in the first region may be at least 6 μL/cm², preferably at least 8 μL/cm² and more preferably at least 10 μL/cm² and the volume of liquid crystal material printed per unit area in the second region may be not more than 4 μL/cm², preferably not more than 3 μL/cm² and more preferably not more than 2 μL/cm². The wavelength of peak reflectance of the first region may be at least 10 nm, preferably at least 20 nm, and more preferably at least 30 nm, shorter than the wavelength of peak reflectance of the second region. The wavelengths are preferably viewed perpendicular to the substrate and preferably with a coaxial light source and viewing device.

Preferably the liquid crystal material is a cholesteric liquid crystal material. Yet more preferably the liquid crystal material is a chiral nematic liquid crystal material. Cholesteric and chiral nematic liquid crystal materials may be particularly suited to the present invention and may show a particularly striking visual effect.

Preferably the first region abuts the second region. The visual effects of the invention may be more readily perceived by the human eye when the first region and the second region abut one another.

Preferably the first and second regions are part of an insignia, marking or code wherein different regions of the insignia are printed with the liquid crystal material at different volumes per unit area. For example, the first and second regions may form part of a bar code. The bar code may be one or two dimensional. Two dimensional barcodes are commonly referred to as QR codes. Bar codes are commonly used to record variable data on products and packaging. An advantage of the present invention is that it uses inkjet printing, which can be used to print variable information, thus allowing the creation of a security device containing variable information and exhibiting different colours in different regions despite being printed with the same liquid crystal material. Preferably the security device includes variable information specific to that device, such as information representing a serial number or other product code. The barcodes are typically formed of discrete elements, or bars, and barcodes according to the invention preferably have a first element printed with a first volume of liquid crystal material per unit area and a second element printed with a second volume of liquid crystal material per unit area such that the wavelength of peak reflectance of the first element is different from the wavelength of peak reflectance of the second element.

Preferably, there are further regions, in addition to the first and second regions, which also exhibit different volumes of liquid crystal material per unit area. The first, second and further regions may be arranged according to a design which aids in the authentication of a product or item. The regions, with different volumes of liquid crystal material per unit area, may be arranged according to a design or rule, so as to permit more ready authentication. Such as design could be a radial, linear, non-linear or geometric arrangement or patterning of the regions with different volumes of liquid crystal material per unit area, for example. There may be further regions printed or coated with another material, such as a conventional ink or a different liquid crystal material. Such regions may add to the visual effect of the invention, and may result in advantageous security devices, but are not essential to the invention. Security devices of the invention have a first region having a first volume of a liquid crystal material printed per area and a second region having a second volume of the same liquid crystal material printed per area such that the first region has a first wavelength of peak reflectance of the liquid crystal material and the second region has a second wavelength of peak reflectance of the liquid crystal material, the first wavelength of peak reflectance being different to the second wavelength of peak reflectance.

Preferably, in at least a region of the insignia, marking or code, the volume of the liquid crystal material printed per unit area of the substrate varies across the region. Thus a change in the wavelength of peak reflectance occurs across the region, which is visible as a gradual change in colour across the region. That may be advantageous for producing a transition zone between the first region and the second region or for creating memorable visual effects, such as images.

The wavelength of peak reflectance may be determined by plotting a spectrum of intensity of reflected light against wavelength. The liquid crystal material will typically reflect light across a relatively narrow band of wavelengths. The wavelength of peak reflectance can be determined for example using the peak picking function of a spectrometer. The wavelength of peak reflectance could for example be determined by fitting a curve, for example a Gaussian curve, through the spectrum and analysing the maximum of that curve. Fitting a curve and analysing that curve may mitigate errors due to uncertainties in the values close to the peak or errors due to inadequately resolved spectra around the peak. The skilled person is able to determine the peak in a reflectance spectrum and the precise peak finding method used is not critical to the invention. It is sufficient that there is a difference in the wavelength of the peak reflectance in the first region and in the second region when a consistent peak finding method is used in both regions. Preferably the difference in the wavelength of peak reflectance is such that the first region has a different colour to the second region when viewed by eye. For example, the first region may be orange and the second region red; or the first region may be yellow and the second region green. Preferably the wavelength of peak reflectance in the second region is different by at least 10 nm, preferably at least 20 nm, more preferably at least 30 nm and most preferably at least 40 nm to the wavelength of peak reflectance in the first region.

Preferably the liquid crystal material exhibits a variation in colour with viewing angle. Thus there is preferable a colour shift in the first and second regions with viewing angle. As well as varying the wavelength of the peak reflectance, printing the liquid crystal material at different volumes per unit area advantageously also affects the shift in the colour of the liquid crystal material with viewing angle. Preferably the liquid crystal material exhibits a variation in colour with viewing angle and the variation in colour is different in the first region to the second region. Preferably, on changing the viewing angle of the device, the wavelength of peak reflectance in the first region changes by a first amount and the wavelength of peak reflectance in the second region changes by a second amount, the first amount being different to the second amount. That is particularly advantageous as not only is the colour different between the regions, but also, as the device is tilted, the colours in the two regions change differently. The overt security feature may thus be one that is readily discernible to an inexpert observer and therefore particularly valuable for marking products to allow their authenticity to be verified. Preferably the change of colour of the first region is greater than the change of colour of the second region. For example, the colour in the first region may change from orange to green when the security device is tilted through 45°, while the colour in the second region may change from a dark red to red.

For example, when changing the viewing angle of the security device from a viewing angle of 90° (i.e. perpendicular) to the substrate to a viewing angle of 45° the amount by which the wavelength of peak reflectance of the first region shifts may differ from the amount by which the wavelength of peak reflectance of the second region shifts by at least 5 nm, more preferably by at least 10 nm. Thus changing the viewing angle by 45° may result in a first shift in wavelength of peak reflectance in the first region and a second shift in wavelength of peak reflectance in the second region, the first shift differing from the second shift by at least 5 nm and preferably by at least 10 nm.

The substrate may be a label, a carton, a packaging container, a surface of a product, a document, a paper substrate, a metallic substrate, a tamper evident substrate, a polymer substrate, a glass substrate or a PET substrate. It is a particular advantage of the invention that the security device can be formed on a wide variety of substrates. Preferably the substrate is the surface of a product. It will be understood that this is preferably an end product, such as a consumer product or industrial product, that is sold and whose authenticity may therefore require verification at a later date. By printing directly onto the product, for example as a step on a production line, the invention permits the creation of security devices on the products without disrupting the rate of production of the products. The security device preferably includes variable data relating to the product, such as a serial number or time of manufacture. The data may be included as plain text or may be encoded, for example in a machine readable format, such as a bar code.

Preferably the substrate is a dark substrate. The dark substrate may be light absorbing and/or non- or minimally-reflective. It may be a black substrate. The dark substrate may be a layer of dark, preferably black, ink printed or coated onto a surface. The visual features of the security device are advantageously more readily discernible when printed on such a substrate. For example, the colours may be more vibrant against a dark substrate.

According to a second aspect of the invention, there is provided a security device obtainable by a method according to the invention, for example according to the first aspect. Preferably there is provided a security device obtained by a method according to the invention, for example according to the first aspect.

According to a third aspect of the invention, there is provided a security device comprising a first region comprising a first volume of a liquid crystal material per unit area of the security device and a second region comprising a second volume of the liquid crystal material per unit area of the security device, wherein the wavelength of the peak reflectance of the liquid crystal material in the first region is different to the wavelength of the peak reflectance of the liquid crystal material in the second region. As discussed above, such a device may produce a striking overt visual effect, whilst maintaining the covert features of the liquid crystal material and being produced in a cost-effective manner by using the same liquid crystal material in both regions. The liquid crystal material may be in the form of discrete drops, or may be a continuous coating formed, for example, by the coalescence of a plurality of drops.

In the first region, the liquid crystal material may have a first average thickness and in the second region, the liquid crystal material may have a second average thickness. The first and second average thickness may be in the range of not less than 0.1 μm to not greater than 200 μm, preferably in the range of not less than 1 μm to not greater than 150 μm, and most preferably in the range of not less than 1 μm to not greater than 100 μm. Preferably the first average thickness is at least 1 μm, preferably at least 10 μm and most preferably at least 20 μm greater than the second average thickness. Preferably the liquid crystal material is printed onto the device by inkjet printing. Preferably the device is produced in accordance with the invention, for example in accordance with the first aspect of the invention. Preferably the device is formed on a substrate and the liquid crystal material in the first region has a first volume per unit area of the substrate and the liquid crystal material in the second region has a second volume per unit area of the substrate. The security device may comprise the substrate, for example when the security device is formed on a label, or the security device may exist on the substrate, for example when the substrate is a packaging container such as a carton or when the substrate is the surface of an industrial or consumer product.

According to a fourth aspect of the invention there is provided a method of producing a security device, the method comprising inkjet printing a liquid crystal material onto a first region of a substrate and ink jet printing the same liquid crystal material onto a second region of the substrate, wherein the volume of the liquid crystal material printed per unit area of the substrate in the first region of the substrate is different to the volume of the liquid crystal material printed per unit area of the substrate in the second region of the substrate such that the visible colour of the liquid crystal material on the first region is different to the visible colour of the liquid crystal material on the second region. The different visible colours in the first and second regions may be as a result of different profiles in the reflectance spectra of the first and second regions. For example, the reflectance spectra may have different wavelengths of peak reflectance in the first and second regions. The provision of a security device having different visible colours, for example green and orange, using a single ink may be advantageous in producing a visually striking security device in a time- and cost-effective manner. Preferably the visible colours in the first and second regions change when viewed at different viewing angles and the colour-change in the first region is preferably different to the colour-change in the second region. Such an effect may be difficult to replicate with conventional inks, whilst easy to recognise without special tools or training, and may thus provide a highly effective security device.

According to a fifth aspect of the invention, there is provided a method of authenticating a product, the method comprising providing on the product a security device according to the invention, for example in accordance with the first, second, third or fourth aspects; inspecting the security device at a first viewing angle and identifying a first colour in the first region and a second colour in the second region; comparing the first and second colours to expected first and second colours; and, based on the comparison, verifying the authenticity of the product. The comparison may be carried out, for example, by eye or using a digital device, such as a smartphone with a camera or a bespoke authentication reader. The different colours resulting from the volumes of liquid crystal material per unit area in the first and second regions, provide a striking overt visual feature that can be readily examined to provide a first check of authenticity. For example, a consumer or retailer could confirm the appearance of the security device compared to another security device. An authentication device may comprise a camera and image recognition software that identifies the first and second regions and compares the colour displayed by those regions at the first viewing angle to an expected colour from a database stored either on the device or in a cloud location to which the device communicates. The colours may be compared, preferably using an authentication device, by comparing the reflectance spectra, for example the wavelengths of peak reflectance, of the first and second regions with expected reflectance spectra, for example expected wavelengths of peak reflectance, for those regions.

Additionally, or alternatively, the method may comprise: inspecting the security device at a second viewing angle and identifying a first shift in the first colour in the first region and a second shift in the second colour in the second region; comparing the first and second shifts to expected first and second shifts; and, based on the comparison, verifying the authenticity of the product. Such an inspection may be achieved by tilting the device and observing the colour shift. A particularly advantageous feature of the device is that the shifts in the first and second regions are different, and that difference may be readily identified, even by an untrained observer, when the shifts are viewed simultaneously on tilting of the security device. The shifts may thus provide a striking overt security feature.

Preferably the authenticating is carried out using an authentication device that identifies the first and second regions and compares colours of the regions with expected colours. Preferably the authentication device compares the colours by comparing features of measured reflectance spectra with features of expected reflectance spectra. Preferably the authentication device comprises a camera and image recognition software to identify the first and second regions. The authentication device may comprise a smartphone. The shifts may also be measured by the authenticating device, for example a device comprising a camera and image recognition software that identifies the first and second regions and compares the shifts in those two regions as the security device is tilted. Preferably the image recognition software calculates viewing angle by comparing relative positions of features of the security device. The authentication device may compare the reflectance spectra, for example the wavelengths of peak reflectance, of the first and second regions at first and second viewing angles with expected reflectance spectra, for example expected wavelengths of peak reflectance, for those regions at those viewing angles. Preferably the authentication device automatically calculates the viewing angle, for example by comparing the relative positions of features of the security device. As the viewing angle of the device changes, the relative positions of the features will change and the authentication device preferably tracks the features and calculates the change in viewing angle. The device preferably records the image of the device at the correct viewing angles and compares the colours of the image with the colours of an expected image at those angles.

In some embodiments, the inspecting may be carried out using a microscope. That may advantageously permit the inspection of small regions, for example variations printed along a single line, that may not be discernible by eye. In that way, a covert security feature may be provided.

Cholesteric liquid crystals are known to reflect circularly polarised light which can be selectively transmitted or extinguished by a circular polarising filter. Surprisingly it has been found that the degree of extinction exhibited when viewing through the circular polarising filter varies with the volume of liquid crystal applied per unit area. Thus, additionally, or alternatively, the method may comprise viewing the first and second regions through a polarising filter, wherein the verifying further comprises identifying that the first colour of the first region is extinguished by the polarising filter to a different extent to the second colour of the second region. Such an effect may form the basis of an authentication device, which comprises the polarising filter. The method may comprise viewing the security device by eye with and without the polarising filter, for example by moving an authentication device comprising the filter across the security device. Preferably, the authenticating is carried out using an authentication device having a camera and a polarising filter, wherein the authentication device captures an image of the security device using the camera both with and without the polarising filter. For example, the authentication device may include a polarising filter that can be moved between a first position, in which the camera captures images through the polarising filter, and a second position, in which the camera captures images without the polarising filter. The authentication device may further comprise image recognition software to compare the images and identify the extent to which the first colour of the first region and the second colour of the second region are extinguished by the polarising filter. The extent to which the colours are extinguished may then be compared to expected values.

The authentication device preferably stores expected images, colours or values in a database either on the authentication device or in a cloud location to which the authentication device has access.

It will be appreciated that features described in relation to one aspect of the invention may be equally applicable to other aspects of the invention. For example, features described in relation to a method of producing a security device of the invention may be equally applicable to a security device of the invention or a method of authenticating a product of the invention and vice versa. It will also be appreciated that optional features may not apply, and may be excluded from, certain aspects of the invention.

### DESCRIPTION OF THE DRAWINGS

The invention will be further described by way of example only with reference to the following figures, of which:

FIG. 1 is a print pattern, or bitmap, used to create test images, not according to the invention, and security devices according to the invention;

FIG. 2 is a test image, not according to the invention, printed with magenta ink using the print pattern of FIG. 1 and viewed at a first angle;

FIG. 3 is the test image of FIG. 2, viewed at a second angle;

FIG. 4 is a test image, not according to the invention, printed with cyan ink using the print pattern of FIG. 1 and viewed at a first angle;

FIG. 5 is the test image of FIG. 4, viewed at a second angle;

FIG. 6 is a security device according to the invention printed with a liquid crystal material using the print pattern of FIG. 1;

FIG. 7 is a security device according to the invention printed with a liquid crystal material using the print pattern of FIG. 1 and viewed at a first angle;

FIG. 8 is the security device of FIG. 7 viewed at a second angle;

FIG. 9 is a security device according to the invention printed with a liquid crystal material using the print pattern of FIG. 1 and viewed at a first angle;

FIG. 10 is the security device of FIG. 9 viewed at a second angle;

FIG. 11 is a security device according to the invention printed with a liquid crystal material using the print pattern of FIG. 1 and viewed at a first angle;

FIG. 12 is the security device of FIG. 11 viewed at a second angle;

FIG. 13 is a security device according to the invention printed with a liquid crystal material using the print pattern of FIG. 1 and viewed at a first angle;

FIG. 14 is the security device of FIG. 13 viewed at a second angle;

FIG. 15a is a graph of reflectance intensity against wavelength in regions of the security device of FIG. 13 viewed at 90° to the substrate;

FIG. 15b is a graph of reflectance intensity against wavelength in regions of the security device of FIG. 13 viewed at 45°;

FIG. 16 is a graph of reflectance intensity against wavelengths in regions of a test image, not according to the invention, with different volumes of magenta ink per unit area;

FIG. 17 is a graph of reflectance intensity against wavelengths in regions of a test image, not according to the invention, with different volumes of cyan ink per unit area;

FIG. 18 is a print pattern, or bitmap, used to create security devices according to the invention;

FIG. 19 is a security device according to the invention printed with a liquid crystal material using the print pattern of FIG. 18 and viewed at a first angle;

FIG. 20 is the security device of FIG. 19 viewed at a second angle;

FIG. 21 is a print patent used to create security devices according to the invention;

FIG. 22 is a security device according to the invention printed with a liquid crystal material using parallel repeats of the print pattern of FIG. 21;

FIG. 23 is a portion of the security device of FIG. 22 viewed through a microscope; and

FIG. 24 is another portion of the security device of FIG. 22 viewed through a microscope.

### DETAILED DESCRIPTION

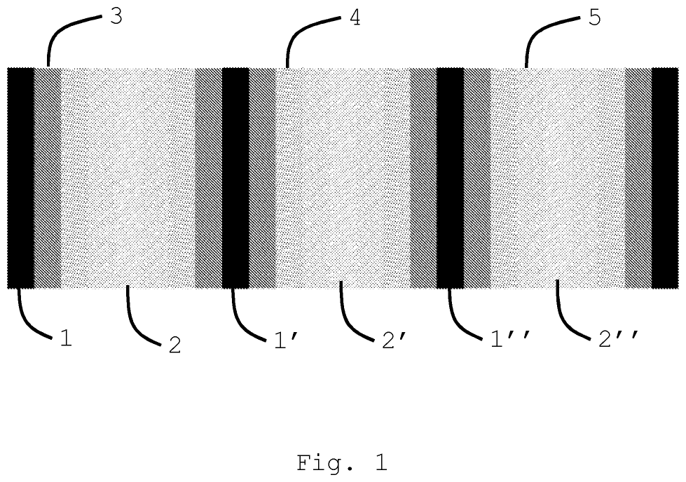

In FIG. 1 a print pattern, or bitmap, comprises a plurality of regions in the form of vertical bands. A first region 1 is to be printed with a high volume of material per unit area. A second region 2 is to be printed with a low volume of material per unit area. Further regions 3, 4, 5 are to be printed with different, intermediate volumes of material per unit area. The regions are printed in a repeating pattern so that there are repetitions of, for example, the first region 1, 1′, 1″ and the second region 2, 2′, 2″ across the pattern.

The first region 1 is printed at 2540×2540 DPI (dots per inch), which equates to a volume of material per unit area of 10 μL/cm². The second region 2 is printed at 508×2540 DPI, which equates to a volume of material per unit area of 2 μL/cm². Intermediate regions 3, 4, 5 are printed at 1270×2540 DPI, 847×2540 DPI and 635×2540 DPI respectively, which equate to a volume of material per unit area of 5 μL/cm², 3.3 μL/cm² and 2.5 μL/cm² respectively. When printed with droplets of 10 μL, 2540 DPI equates to a droplet spacing of 10 μm and 635 DPI equates to a droplet spacing of 40 μm. The print pattern is used to print test images, not according to the invention, using conventional magenta and cyan inks (available from Mimaki) and security devices according to the invention using liquid crystal materials. Examples of liquid crystal materials suitable for inkjet printing are disclosed in WO2008/110342 and WO2008/110317. Such formulations typically contain a non-reactive liquid crystal, mono-acrylate liquid crystal, diacrylate liquid crystal, chiral dopant, photo initiator and inhibitor. Other such formations typically contain mono-acrylate liquid crystal, diacrylate liquid crystal, chiral dopant, photo initiator and inhibitor. The test images and the security devices were printed in a multi-pass manner using a Fujifilm Dimatix DMP2831 printer (Fujifilm, United States). With the DMP2831 printing occurs on the outbound motion of the print head away from the blotter, which when complete, is followed by incremental advance of the platen in a manner perpendicular to the direction of printing. The procedure then repeats until the image has been completed. The controlling software regards the print resolution as being defined by the angle at which the print head is positioned relative to the direction of printing. However, if the data file, or bitmap, for the image has regions of varying pixel density, then even though the sabre angle of the printer does not vary whilst printing is underway, images where the print resolution varies throughout the image can still be achieved. An example bitmap is shown in FIG. 1.

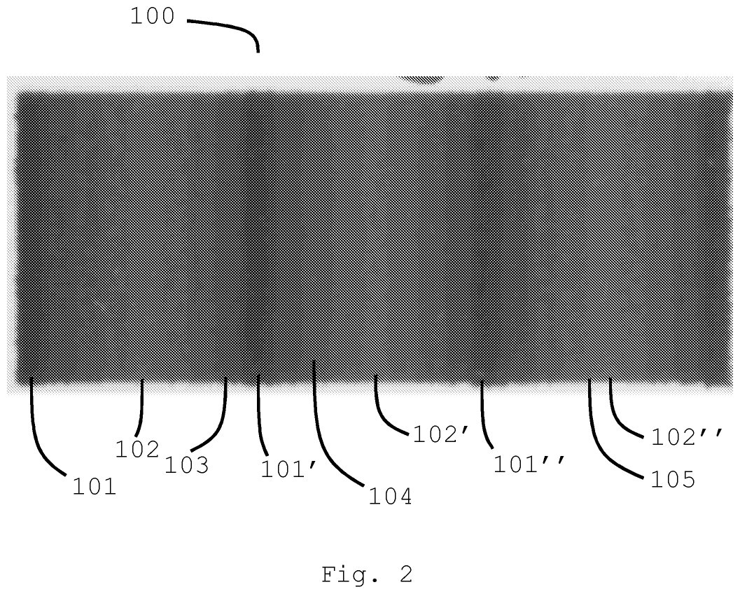

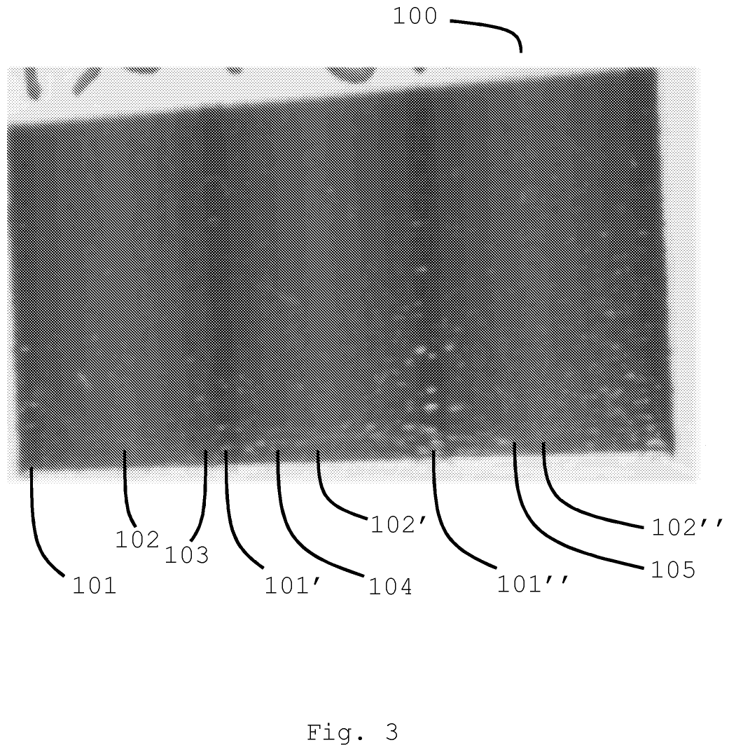

In FIGS. 2 and 3 a test image 100, not according to the invention, has been printed using a conventional magenta ink and the print pattern of FIG. 1. While the first regions 101, 101′, 101″ are darker than the secondary regions 102, 102′, 102″, with the intermediate regions 103, 104, 105, having intermediate shades, all the regions show the same magenta hue. Moreover, the hue is the same whether viewed perpendicular to the substrate (FIG. 2) or at 45° to the substrate (FIG. 3).

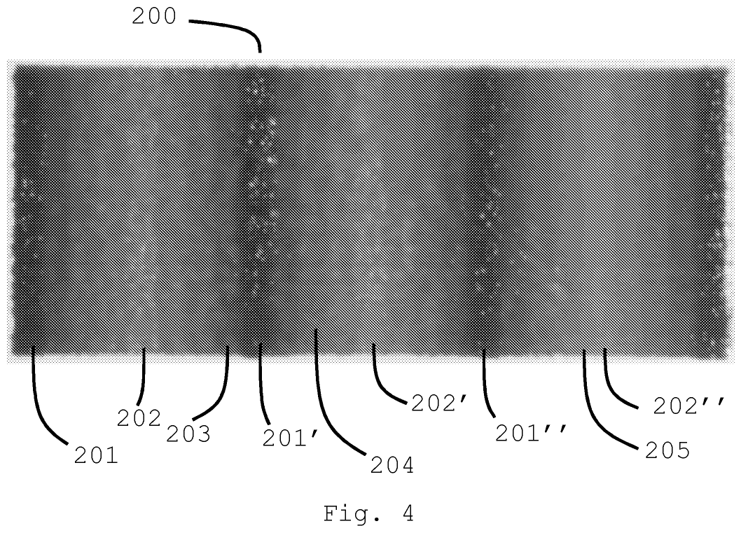

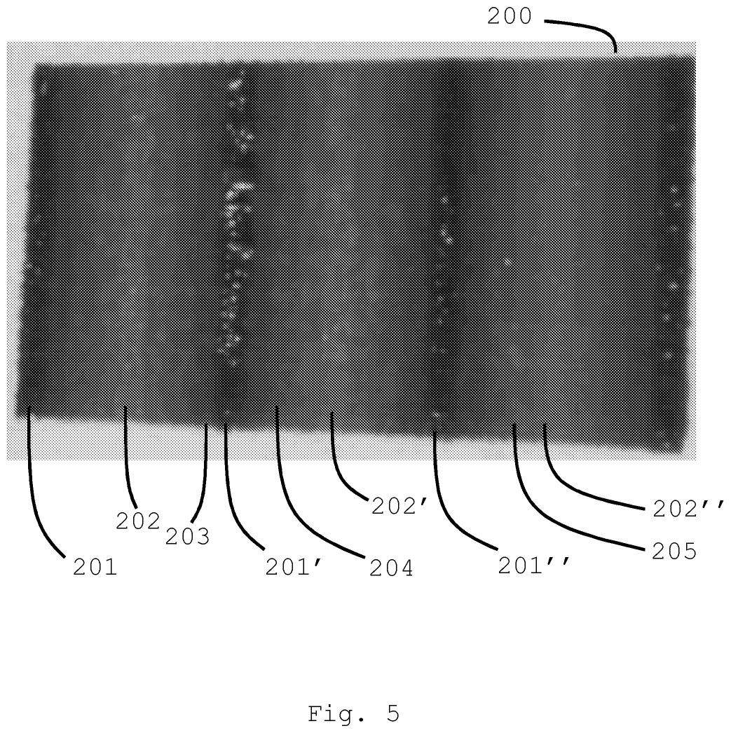

In FIGS. 4 and 5 a test image 200, not according to the invention, has been printed using a conventional cyan ink and the print pattern of FIG. 1. As with the test image 100, the regions in the test image 200 show the same colour in lighter or darker shades. The first regions 201, 201′, 201″ are darker than the secondary regions 202, 202′, 202″, with the intermediate regions 203, 204, 205, having intermediate shades. However, all the regions show the same blue colour and the colours are the same whether viewed perpendicular to the substrate (FIG. 4) or at 45° to the substrate (FIG. 5).

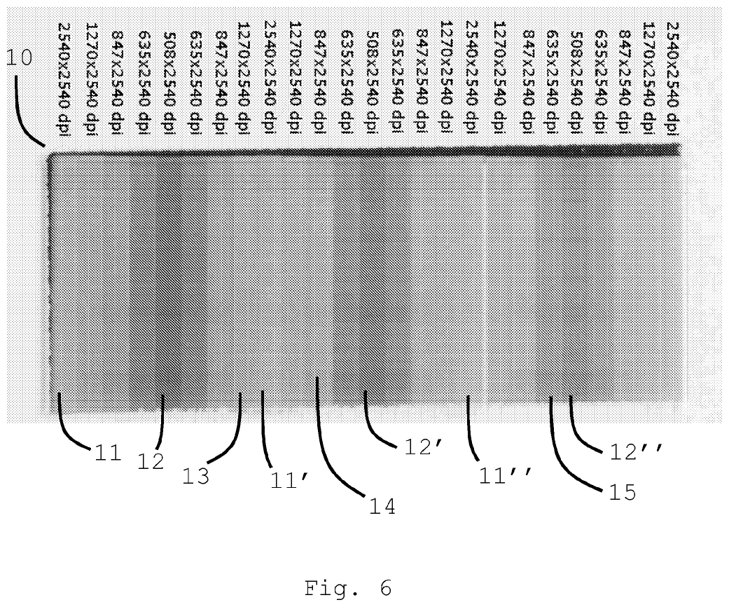

In FIG. 6 a security device 10 according to the invention has been printed using a liquid crystal material and the print pattern of FIG. 1. The substrate onto which the liquid crystal material is printed is glass. The first regions 11, 11′, 11″ are a green-orange colour, while the second regions 12, 12′, 12″ are a brown colour. Intermediate regions 13 and 14 are a pale orange and orange colour, respectively, while intermediate region 15 is a pale brown colour. The colour thus transitions from the green-orange colour of the first regions 11, 11′, 11″ to the brown colour of the second regions 12, 12′, 12″ via intermediate colours in the intermediate regions 13, 14, 15. The different colours are readily apparent to the eye and thus form a striking visual effect despite all the regions 11, 12, 13, 14, 15 being printed with the same liquid crystal material.

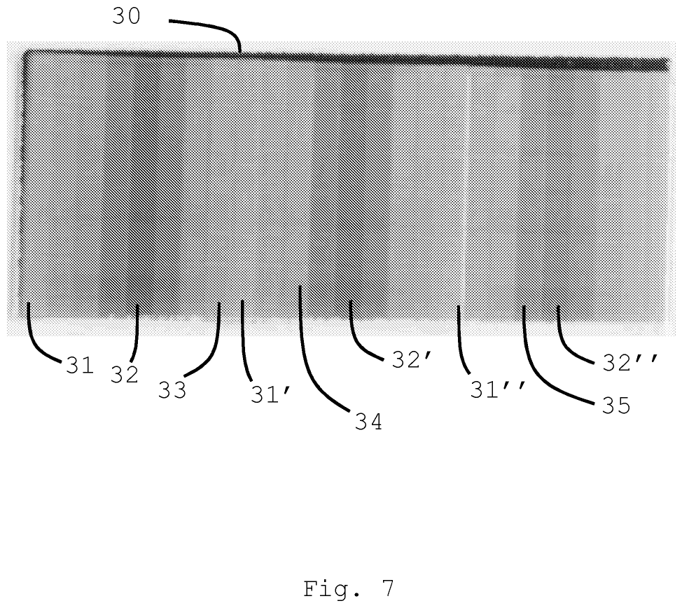

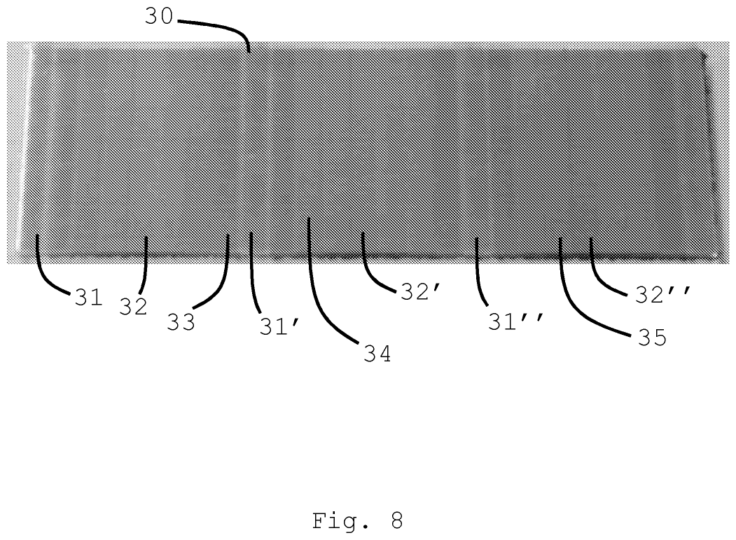

In FIGS. 7 and 8 a security device 30 according to the invention, similar to the security device 10 in FIG. 6, is viewed perpendicular to the substrate (FIG. 7) and at 45° to the substrate (FIG. 8). The security device 30 is also printed onto a glass substrate. As described above in relation to FIG. 6, in FIG. 7 the first regions 31, 31′, 31″ are a green-orange colour and the second regions 32, 32′, 32″ are a brown colour. The intermediate regions 33, 34, 35 are pale orange, orange and pale brown respectively. When, in FIG. 8, the security device 30 is viewed at 45° to the substrate, the colour of the first regions 31, 31′, 31″ shifts to a blue-green colour and the colour of the second regions 32, 32′, 32″ shifts to an olive green colour. The intermediate regions 33, 34, 35 are intermediate colours. Thus the brown colour of the second regions 32, 32′, 32″ has shifted to an olive green and the green-orange colour of the first regions 31, 31′, 31″ has shifted to a blue-green. This results in a useful overt security feature since the different colour shifts, especially when viewed simultaneously next to each other as the security device 30 is tilted, produce a memorable visual effect that cannot be replicated with conventional inks. Since the effect is produced using a single liquid crystal material, the security device 30 can be manufactured in a cost and time effective manner.

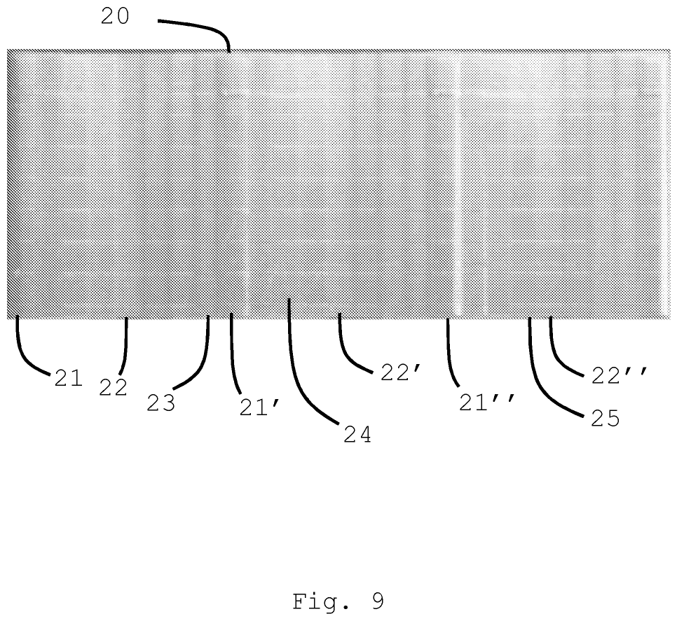

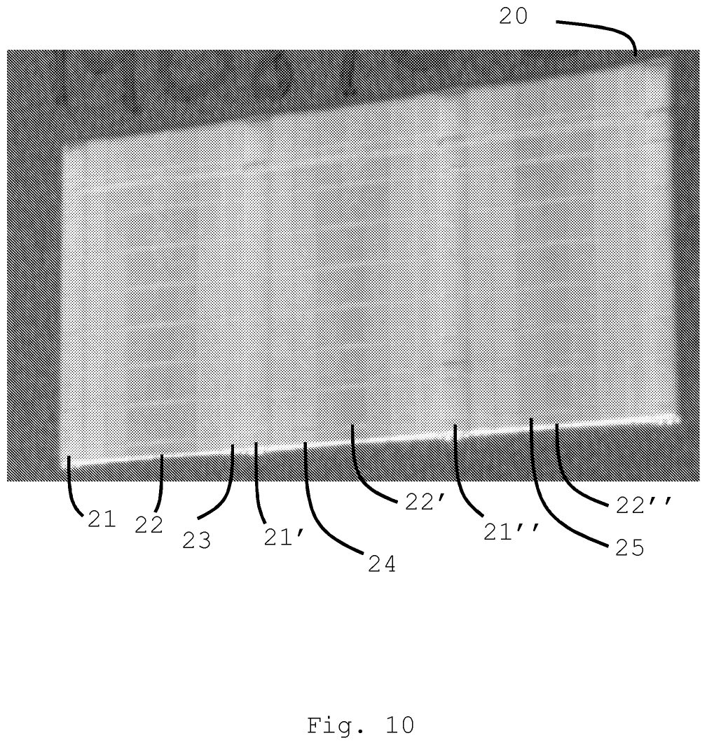

In FIGS. 9 and 10 a security device 20 according to the invention is viewed perpendicular to the substrate (FIG. 9) and at 45° to the substrate (FIG. 10). The substrate is a Mylar based tamper evident label. In FIG. 9 the first regions 21, 21′, 21″ are an orange colour and the second regions 22, 22′, 22″ are a yellow-green colour. The intermediate regions 23, 24, 25 transition from the orange of the first regions 21, 21′, 21″ to the yellow-green of the second regions 22, 22′, 22″. When, in FIG. 10, the security device 20 is viewed at 45° to the substrate, the colour of the first regions 21, 21′, 21″ shifts to a bright green colour and the colour of the second regions 22, 22′, 22″ shifts to a deep blue-green colour. The intermediate regions 23, 24, 25 are intermediate colours. The result is a striking change from an overall impression of yellow-greens and oranges to an overall impression of greens and blue-greens, with a particularly noticeable effect in the visually greater shift in colour, from orange to bright green, in the first regions 21, 21′, 21″ when compared to the lesser shift in colour, from yellow-green to blue-green, in the nearby second regions 22, 22′, 22″. The ability to make a security device 20 with varying colours and with varying degrees in the shift of those colours with viewing angle using a single liquid crystal material is an important advantage of the invention.

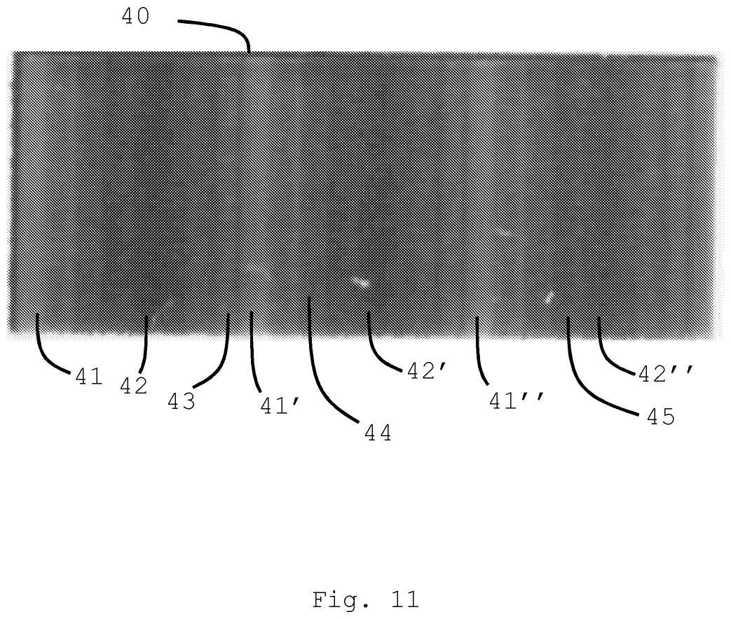

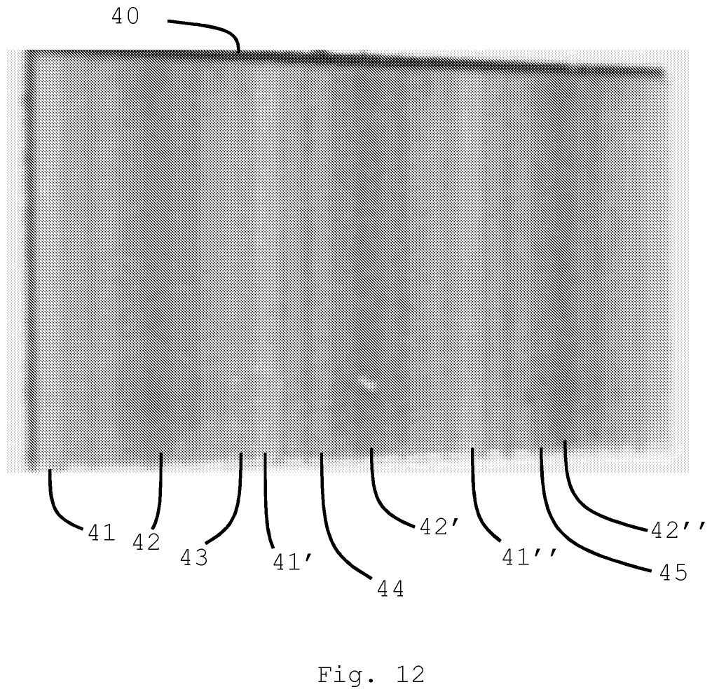

In FIGS. 11 and 12 a security device 40 according to the invention is viewed perpendicular to the substrate (FIG. 11) and at 45° to the substrate (FIG. 12). The substrate is a dark substrate created by printed a black image onto Teknocard (Arjowiggins). In FIG. 11 the first regions 41, 41′, 41″ are a red-orange colour and the second regions 42, 42′, 42″ are a deep-red colour. The intermediate regions 43, 44, 45 are intermediate colours. The colour difference between the first regions 41, 41′, 41″ and the second regions 42, 42′, 42″ provides a first level of authentication capability. However, most advantageously, there is a striking visual effect when the security device 40 is tilted so as to be viewed at 45° to the substrate (FIG. 12). At that angle, the colour of the first regions 41, 41′, 41″ shifts to a bright green colour, while the colour of the second regions 42, 42′, 42″ shifts to a lesser extent to a red-orange colour. The intermediate regions 43, 44, 45 are intermediate colours. The visually greater shift in colour, from red-orange to bright green, in the first regions 41, 41′, 41″ when compared to the lesser shift in colour, from deep-red to red-orange, in the nearby second regions 42, 42′, 42″ creates an effect that is immediately recognisable even to an unskilled observer. The effect is achieved with a single liquid crystal material, which results in a security device 40 that is simple to manufacture yet effective in providing a recognisable effect for authentication that is difficult to replicate by other means.

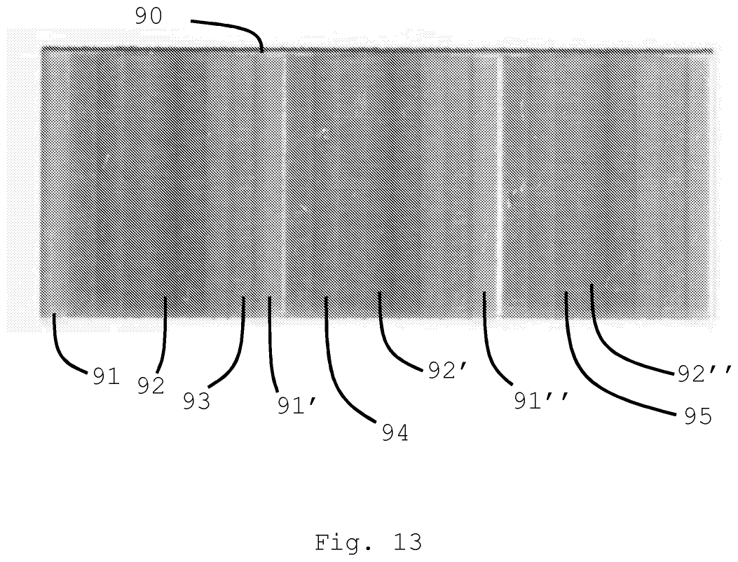

In FIGS. 13 and 14 a security device 90 according to the invention is viewed perpendicular to the substrate (FIG. 13) and at 45° to the substrate (FIG. 14). The substrate is card. In FIG. 13 the first regions 91, 91′, 91″ are a green colour and the second regions 92, 92′, 92″ are an orange colour. The intermediate regions 93, 94, 95 are intermediate colours. The colour difference between the first regions 91, 91′, 91″ and the second regions 92, 92′, 92″ provides a first level of authentication capability. However, most advantageously, there is a striking visual effect when the security device 90 is tilted so as to be viewed at 45° to the substrate (FIG. 14). At that angle, the colour of the first regions 91, 91′, 91″ shifts to a blue-green colour, while the colour of the second regions 92, 92′, 92″ shifts to an olive green colour. The intermediate regions 93, 94, 95 are intermediate colours. The different shift in colour, from green to blue-green, in the first regions 91, 91′, 91″ when compared to the shift in colour, from orange to olive green, in the nearby second regions 92, 92′, 92″ creates an effect that is immediately recognisable even to an unskilled observer. The effect is achieved with a single liquid crystal material, which results in a security device 90 that is simple to manufacture yet effective in providing a recognisable effect for authentication that is difficult to replicate by other means.

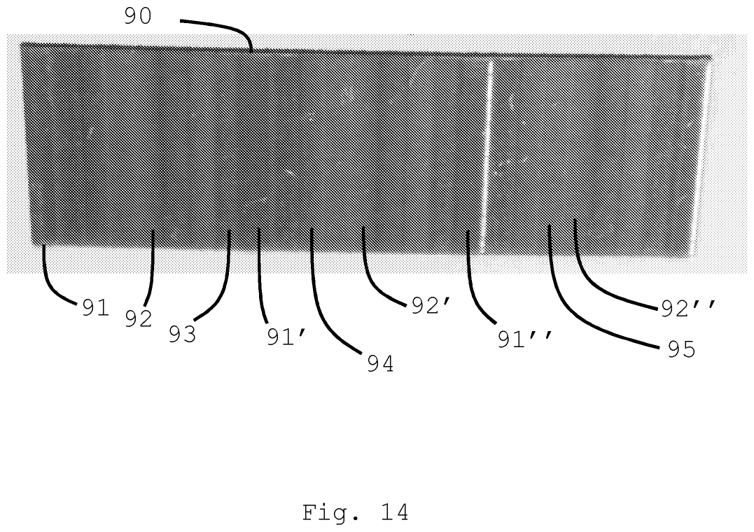

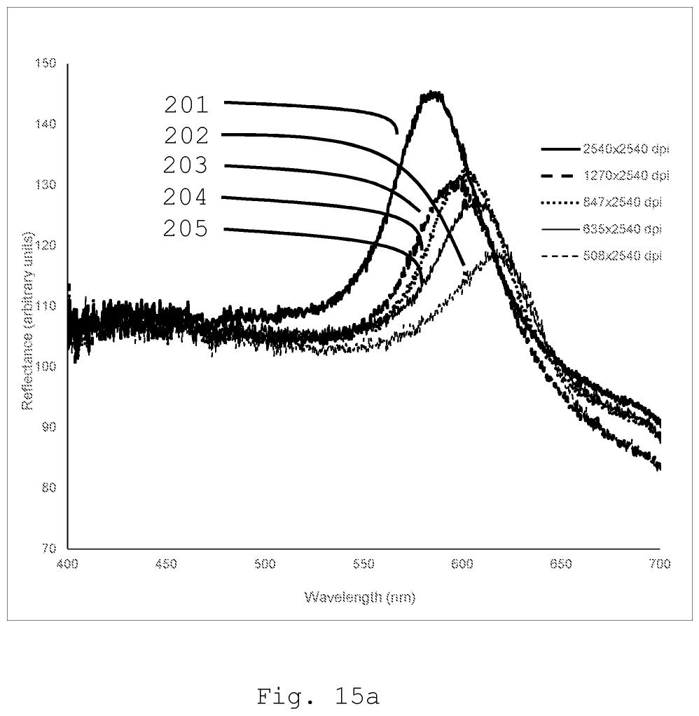

In FIG. 15a, spectra 201, 202, 203, 204, 205 of intensity against wavelength are plotted for different regions of the security device 90 of FIG. 13 viewed, as in FIG. 13, at 900 to the substrate. The security device 90 is viewed at 900 to the substrate with the light source and spectrometer probe coaxial to each other. The spectra are plotted for regions printed at 2540×2540 DPI or 10 μL/cm² (region 91, 91′, 91″, spectrum 201), 1270×2540 DPI or 5.0 μL/cm² (region 93, spectrum 203), 847×2540 DPI or 3.3 μL/cm² (region 94, spectrum 204), 635×2540 DPI or 2.5 μL/cm² (region 95, spectrum 205) and 508×2540 DPI or 2.0 μL/cm² (region 92, 92′, 92″, spectrum 202). Spectrum 201 corresponds to the first region 91, 91′, 91″ of the security device 90 and spectrum 202 corresponds to the second region 92, 92′, 92″ of the security device 90. Spectra 203, 204 and 205 correspond to the intermediate regions 93, 94 and 95 respectively. As the volume of liquid crystal material printed per unit area decreases, the wavelength of peak reflectance (i.e. the peak in the wavelength spectrum) shifts towards longer wavelengths. To the eye, this effect is observed as a change to more red colours with decreasing volume of liquid crystal material printed per unit area.

In FIG. 15b, spectra 201′, 202′, 203′, 204′, 205′ of intensity against wavelength are plotted for the different regions of the security device 90 of FIG. 13 viewed, as in FIG. 14, at 45° to the substrate. The security device 90 is viewed at 45° to the substrate with the light source and spectrometer probe at 90° to each other. Spectrum 201′ corresponds to the first region 91, 91′, 91″ of the security device 90 and spectrum 202′ corresponds to the second region 92, 92′, 92″ of the security device 90. Spectra 203′, 204′ and 205′ correspond to the intermediate regions 93, 94 and 95 respectively. As the volume of liquid crystal material printed per unit area decreases, the wavelength of peak reflectance (i.e. the peak in the wavelength spectrum) still shifts towards longer wavelengths. However, all the wavelengths of peak reflectance are shifted to shorter wavelengths by the tilting of the viewing angle when compared to FIG. 15a. Moreover, the shift from FIG. 15a to FIG. 15b is different for the different regions 91, 92, 93, 94, 95 printed at different volumes of liquid crystal material per unit area. The result, as seen in FIGS. 13 and 14, is that the shift in colour on tilting the security device 90 is different in the different regions 91, 92, 93, 94, 95, which leads to a memorable, and difficult to counterfeit, visual effect.

On viewing the security device 90 at 90° to the substrate, the peak reflectance of the first regions 91, 91′, 91″ printed at 2540×2540 dpi is at a wavelength 30 nm shorter than the wavelength of peak reflectance of the second regions 92, 92′, 92″ printed at 508×2540 dpi. On viewing the security device 90 at a 45° angle to the substrate, the peak reflectance of the first region 91, 91′, 91″ printed at 2540×2540 dpi is at a wavelength 25 nm shorter than the wavelength of the second region 92, 92′, 92″ printed at 508×2540 dpi. Moreover, the peak reflectance of the first region 91, 91′, 91″ viewed at 45° is at a wavelength 50 nm shorter than the wavelength of peak reflectance of the same region 91, 91′, 91″ at a 90° viewing angle.

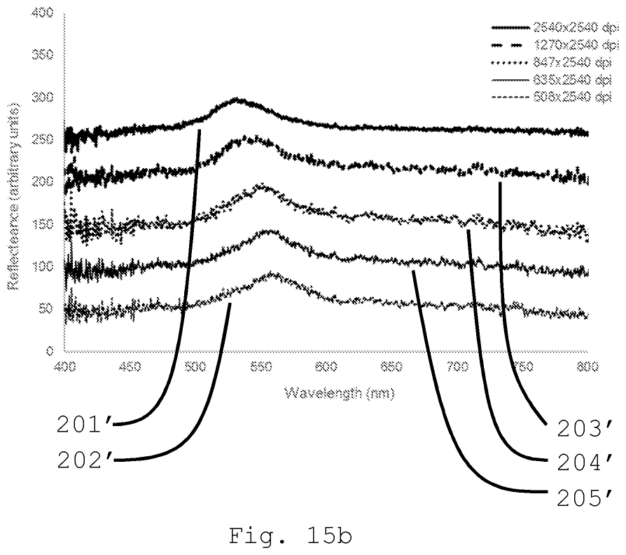

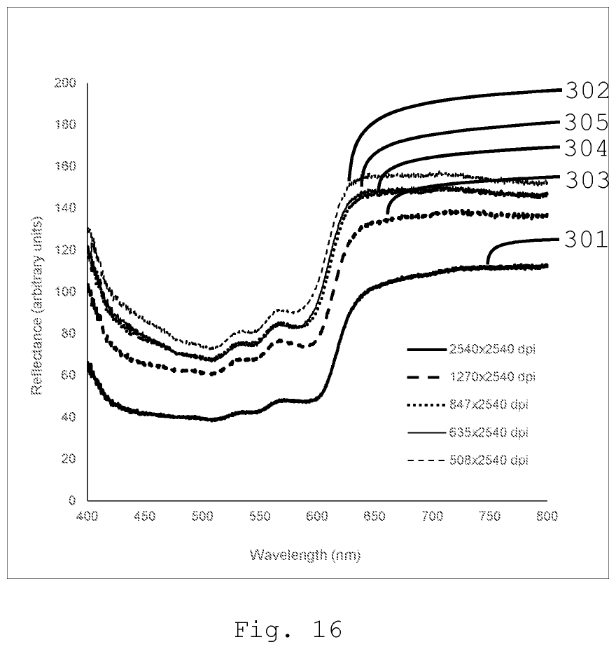

By contrast, in FIG. 16, spectra 301, 302, 303, 304, 305 are plotted for conventional magenta ink in a test image not according to the invention and printed according to the print pattern of FIG. 1. Such a test image may be the image of FIGS. 2 and 3. Similarly, in FIG. 17, spectra 401, 402, 403, 404, 405 are plotted for conventional cyan ink in a test image not according to the invention and printed according to the print pattern of FIG. 1. Such a test image may be the image of FIGS. 4 and 5. In both cases, while the intensity of the peak reflectance decreases with decreasing volume of liquid crystal material printed per unit area, the shape of the reflectance spectrum remains substantially unaltered. To the eye this appears as a paler shade of the same colour. Because there is no peak reflectance with a wavelength that changes with volume of material printed per unit volume, the striking colour difference obtained in the security devices of the invention is not present in the test images.

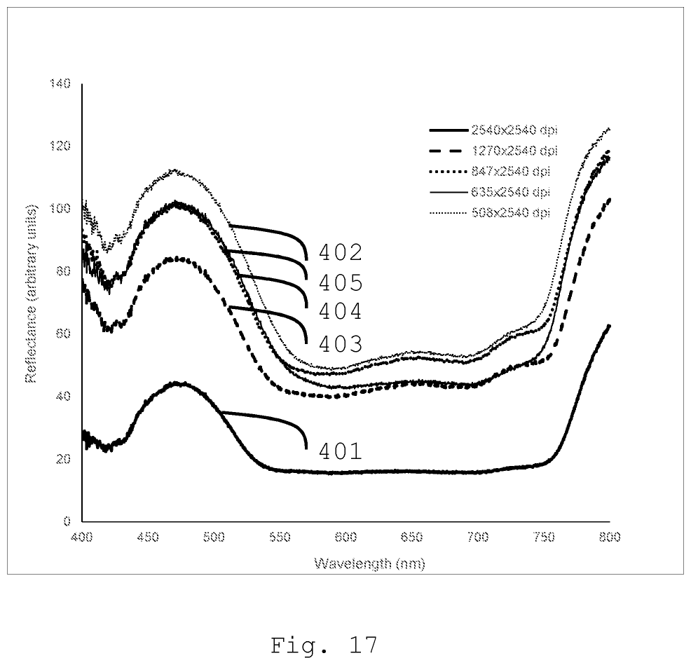

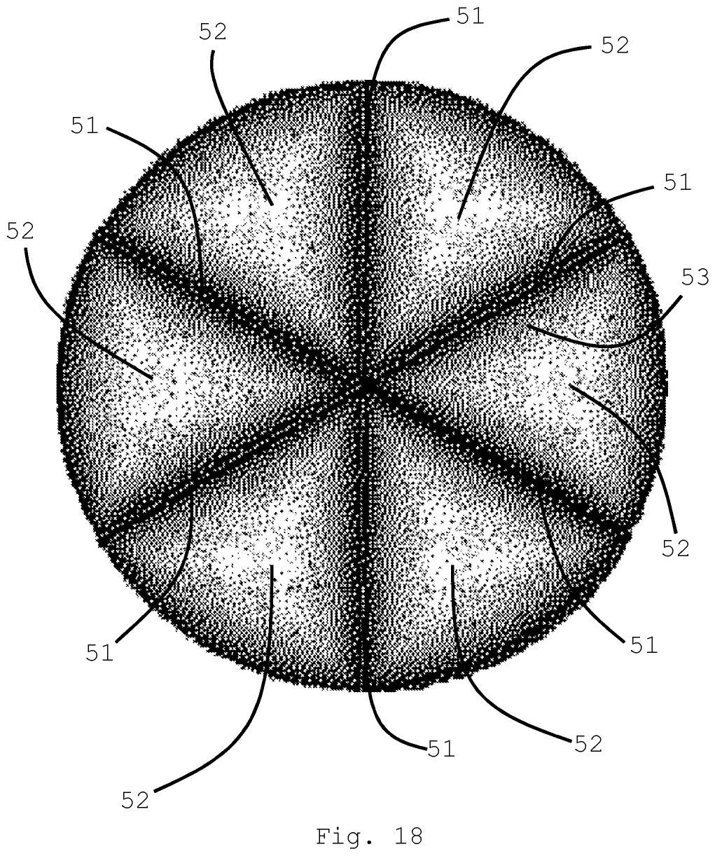

In FIGS. 18, 19 and 20 a security device 60 according to the invention is printed using a print pattern (FIG. 18) comprising areas 51 in which a high volume of liquid crystal material is printed per unit area and areas 52 in which a low volume of liquid crystal material is printed per unit area. Between those regions are regions 53 in which the volume of liquid crystal material printed per unit area changes across the region. The resulting security device 60, when viewed perpendicular to the substrate (FIG. 19) is a striking image of spokes of a wheel. The spokes correspond to the first regions 51 of the print pattern and appear as first regions 61 of the security device 60 having a yellow-orange colour. The second regions 62 of the security device 60 correspond to second regions 52 of the print pattern and are a dark red colour. Between the first regions 61 and the second regions 62, intermediate regions 63 show a transition from the yellow-orange colour of the first regions 61 to the dark red colour of the second regions 62.

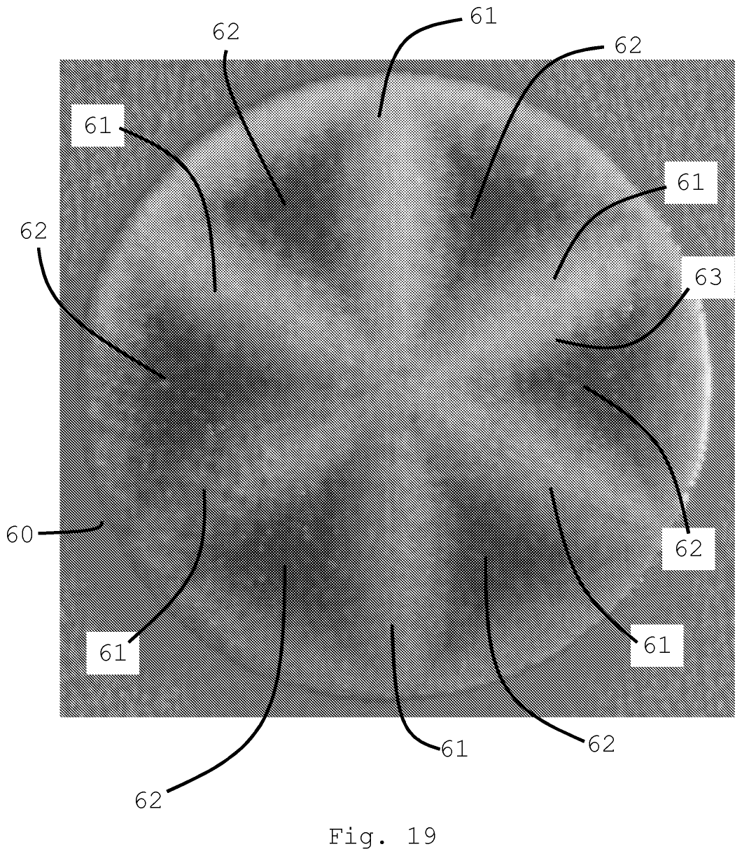

Even viewed perpendicular to the substrate as in FIG. 19, the security device 60 of the invention already provides a memorable visual image with just one liquid crystal material. However, as the security device 60 is tilted to 45° (FIG. 20), the visual effect is even more striking. In FIG. 20, the first regions 61 shift to a bright green colour, while the second regions 62 remain a red colour. The intermediate regions 63 now show a transition from the green of the first regions 61 to the red of the second regions 62, via yellow-green and orange colours. Because not only the wavelength of peak reflectance is different in the first 61 and second 62 regions, but also the extent to which that wavelength is shifted with changing viewing angle is different, the visual characteristics of the device are instantly recognisable to even an unskilled observer. However, those effects are difficult to reproduce by other means. Being able to create such a strong security device 60 by printing a single liquid crystal material in a single print step provides significant advantages in being able to apply the security device 60 to products or their packaging as they are produced even on a high speed production line.

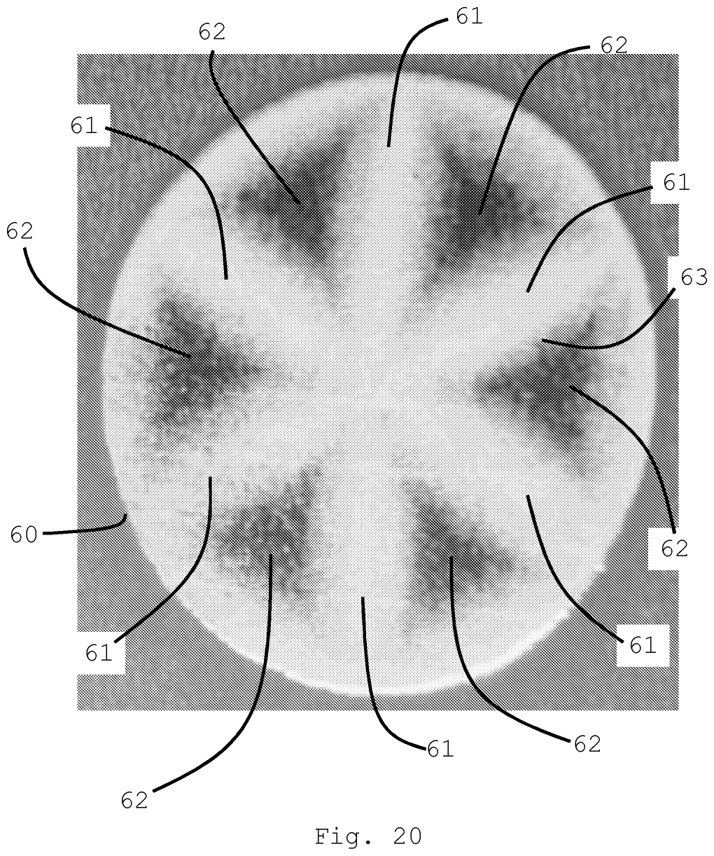

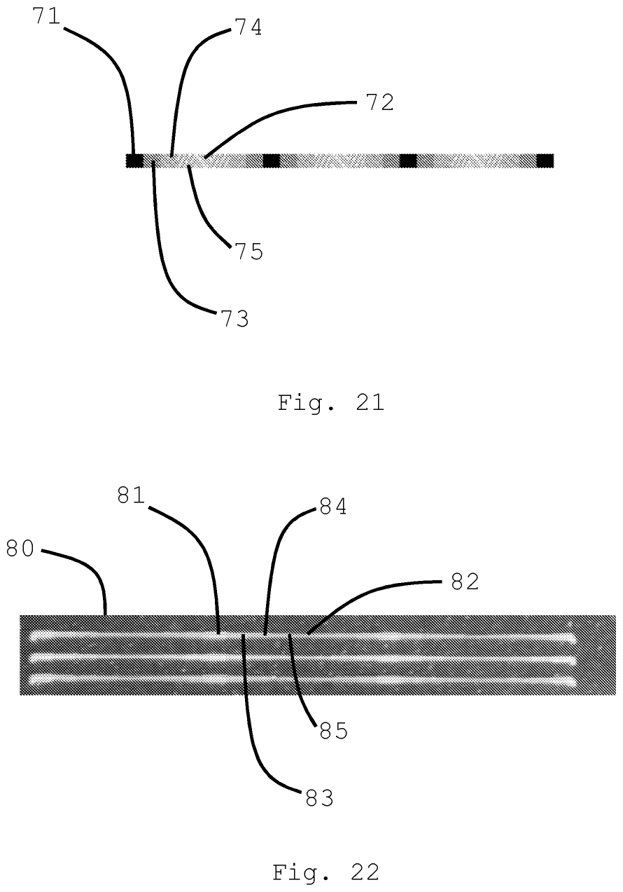

In FIGS. 21 and 22, a security device 80 according to the invention is produced by varying the volume of liquid crystal material printed per unit area along a printed line. The volume of liquid crystal material printed per unit area is changed in discrete regions 71, 72, 73, 74, 75 of the print pattern, resulting in bands of colour in discrete regions 81, 82, 83, 84, 85 of the security device. The first region 81, having the highest volume of liquid crystal material per unit area appears a yellow colour, while the second region 82, having the lowest volume of liquid crystal material per unit area appears a pink colour. The intermediate regions 83, 84, 85 have intermediate colours.

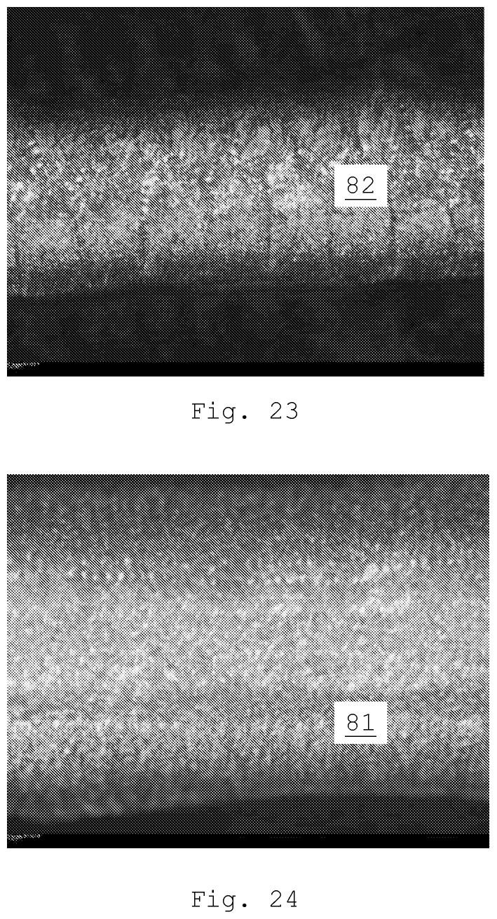

The authenticity of the security device 80 can be further verified by examining the regions 81, 82, 83, 84, 85 under crossed linear polarisers in a microscope. In FIG. 23, the second region 82 shows a distinct pattern of varying colour at the microscopic scale that is distinct from the pattern in the first region 81 in FIG. 24. Thus, while the unskilled observer can confirm authenticity by reference to the overt visual effect, a further, forensic examination of authenticity can be undertaken by a skilled technician using the forensic effect if an even greater level of certainty is required.

It will be appreciated that the embodiments set out above are examples of the invention and that the skilled person would appreciate that variations are possible within the scope of the invention. For example, many different patterns of the first and second regions, and indeed of further regions are possible. Moreover, while the invention is concerned with the presence of a single liquid crystal material printed at different volumes per unit area in different regions of the security device, that can be achieved while also printing or coating further inks or liquid crystal materials in other regions of the security device.

1-21. (canceled)

22. A security device comprising a first region comprising a first volume of a liquid crystal material per unit area of the security device and a second region comprising a second volume of the liquid crystal material per unit area of the security device, wherein the wavelength of the peak reflectance of the liquid crystal material in the first region is different to the wavelength of the peak reflectance of the liquid crystal material in the second region and wherein a visible colour of the liquid crystal material in the first region is different to a visible colour of the liquid crystal material in the second region.

23. The security device according to claim 22, wherein the first volume of the liquid crystal material per unit area of the security device and the second volume of the liquid crystal material per unit area of the security device are both within the range from 0.01 to 20 μL/cm².

24. The security device according to claim 22, wherein the liquid crystal material comprises a cholesteric liquid crystal material.

25. The security device according to claim 22, wherein the first volume of the liquid crystal material per unit area of the security device differs from the second volume of the liquid crystal material per unit area of the security device by at least 10% relative to the first volume of the liquid crystal material per unit area of the security device.

26. The security device according to claim 22, wherein the first volume of the liquid crystal material per unit area of the security device is at least 0.1 μL/cm² greater than the second volume of the liquid crystal material per unit area of the security device.

27. The security device according to claim 22, wherein the first volume of the liquid crystal material per unit area of the security device is at least 6 μL/cm² and the second volume of liquid crystal material per unit area of the security device is not more than 4 μL/cm².

28. The security device according to claim 22, wherein the first region abuts the second region.

29. The security device according to claim 22, wherein the first and second regions each have an area of from not less than 1 mm² to not greater than 1 cm².

30. (canceled)

31. The security device according to claim 22, wherein the wavelength of peak reflectance of the liquid crystal material in the first region is at least 10 nm shorter than the wavelength of peak reflectance of the liquid crystal material in the second region.

32. The security device according to claim 22, wherein the liquid crystal material exhibits a variation in colour with viewing angle and wherein the variation in colour is different in the first region to the second region.

33. The security device according to claim 32, wherein, when changing from a viewing angle of 90° to the security device to a viewing angle of 45° to the security device, the amount by which the wavelength of peak reflectance of the first region shifts differs from the amount by which the wavelength of peak reflectance of the second region shifts by at least 5 nm.

34. The security device according to claim 22, wherein the first and second regions are part of an insignia, marking or code wherein different regions of the insignia, marking or code have different volumes of liquid crystal material per unit area of the security device.

35. The security device according to claim 34, wherein in at least a region of the insignia, marking or code the volume of the liquid crystal material per unit area of the security device varies across the region.

36-41. (canceled)

42. A method of authenticating a product, the method comprising providing on the product a security device according to claim 22;
inspecting the security device at a first viewing angle and identifying a first colour in the first region and a second colour in the second region;
comparing the first and second colours to expected first and second colours; and, based on the comparison, verifying the authenticity of the product.

43. The method of authenticating a product according to claim 42, the method further comprising: inspecting the security device at a second viewing angle and identifying a first shift in the first colour in the first region and a second shift in the second colour in the second region; comparing the first and second shifts to expected first and second shifts; and, based on the comparison, verifying the authenticity of the product.

44-50. (canceled)

51. A method of producing a security device according to claim 22, the method comprising:
inkjet printing a liquid crystal material onto a first region of a substrate; and
inkjet printing the same liquid crystal material onto a second region of the substrate,
wherein the volume of the liquid crystal material printed per unit area of the substrate in the first region of the substrate is different to the volume of the liquid crystal material printed per unit area of the substrate in the second region of the substrate such that the wavelength of the peak reflectance of the liquid crystal material on the first region is different to the wavelength of the peak reflectance of the liquid crystal material on the second region and wherein a visible colour of the liquid crystal material in the first region is different to a visible colour of the liquid crystal material in the second region.
